(19) United States
(12) Patent Application Publication
(10) Pub. No.: US 2013/0312588 A1
(43) Pub. Date: Nov. 28, 2013

(54) VIRTUAL AUDIO EFFECTS PEDAL AND CORRESPONDING NETWORK

(71) Applicant: Jesse Harris Orshan, Roslyn Heights, NY (US)

(72) Inventor: Jesse Harris Orshan, Roslyn Heights, NY (US)

(21) Appl. No.: 13/875,072

(22) Filed: May 1, 2013

Related U.S. Application Data
(60) Provisional application No. 61/641,042, filed on May 1, 2012.

(51) Int. Cl. G10H 1/00

(52) U.S. Cl. CPC G10H 1/0091
USPC 84/609

(57) ABSTRACT

A method of playing a digital sound clip, including creating a digital sound clip, and producing, by an amplifier, the digital sound clip in response to a hitting of the note on a guitar.

### CROSS REFERENCE TO RELATED APPLICATION

The present application claims priority to U.S. Provisional Patent Application No. 61/641,042, filed May 1, 2012, the entire contents of which are incorporated herein by reference.

### BACKGROUND

1. Field of the Disclosure

The present disclosure relates, generally, to audio technology and, more particularly, to audio sound effects.

2. Related Art

Musical effects are used by many musicians, including guitarists. The majority of those musicians, particularly those who play for live audiences, employ “effects pedals” for the musical effects and to obtain different sounds when playing.

There is a very large market for effects pedals. Generally, there are two options that musicians have when deciding to make a purchase. First, a musician may purchase individual effect pedals (which may cost between $100-200 dollars). Each of these individual effect pedals creates a specific sound (such as distortion, delay, flanger, chorus, or the like). Although sometimes desirable for having a preferred quality, individual effect pedals are expensive and are cumbersome because of the requirement of having a plurality of the pedals to achieve a variety of audio effects. A musician who wants to have a plurality of effects, typically, needs to purchase a number of individual effect pedals for each respective effect.

Another option for musicians is to purchase a multi-effects pedal. This is an effects pedal that is configured to provide anywhere from a dozen to up to hundreds of audio effects. A multi-effects pedal may range in price between $200-$800. One shortcoming of multi-effects pedals is that a musician, typically, will never use an effect that the musician does not like. This may result in dozens or hundreds of purchased effects that go unused.

The inventor recognizes that certain kinds of music, particularly the type of music that employs effects pedals, is supposed to be about complete freedom and creativity. Unfortunately, musicians are only able to play the sounds that effects companies are willing to sell to them, or must purchase multiple individual effect pedals.

### SUMMARY

The present application provides a way to allow musicians to have greater autonomy over the way their musical instruments sound. In an embodiment, the present application provides an online network in which musicians can share/sell their sound effects. Moreover, in an embodiment, the present application provides a computer program, effects pedals, and a social network. When a user opens the program, the user is able to manipulate basic sound effects in virtually an infinite number of ways and is able to build custom audio effects for use on an effects pedal and that may be distributed over the network.

Some known computer programs, such as LOGIC, include features that allow musicians to customize audio effects. (See, for example, FIGS. 1-4). However, such known applications only allow musicians to record with these effects. The musician has no way to take an effect that (s)he has created out into the world to be played without bringing a laptop computer, computer equipment, and other expensive programs with him/her.

In accordance with the present application, a musician is provided with a way to plug an effects pedal into a computer, upload effects (s)he designed onto the pedal, and then go use that pedal during a live performance.

Other features and advantages of the present invention will become apparent from the following description of the invention that refers to the accompanying drawings.

### BRIEF DESCRIPTION OF THE DRAWING(S)

FIGS. 1-4 illustrate example audio effects, amplifier and effects pedals designs in accordance with the present application.

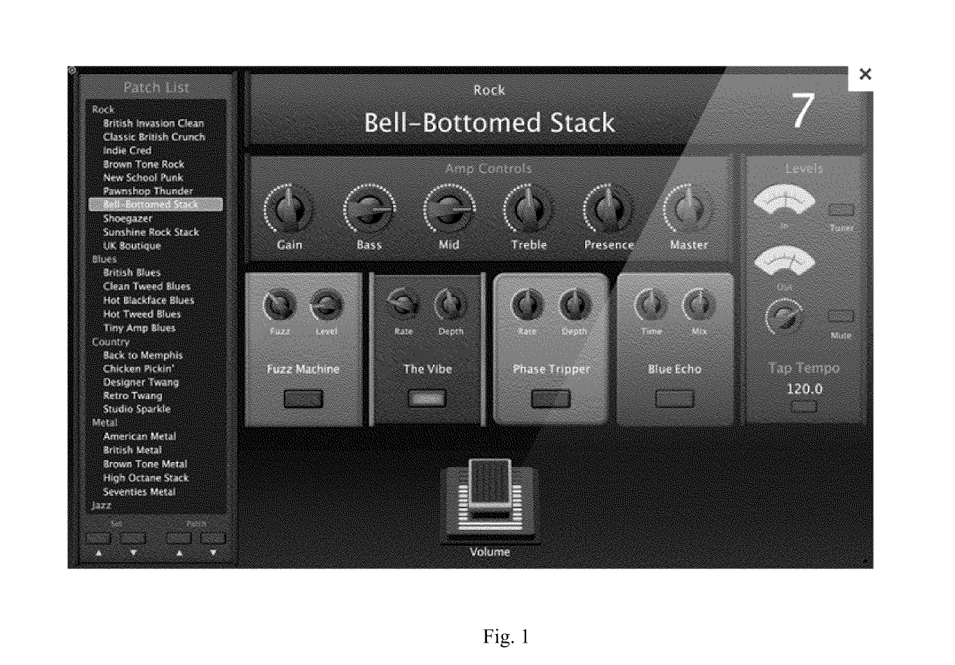

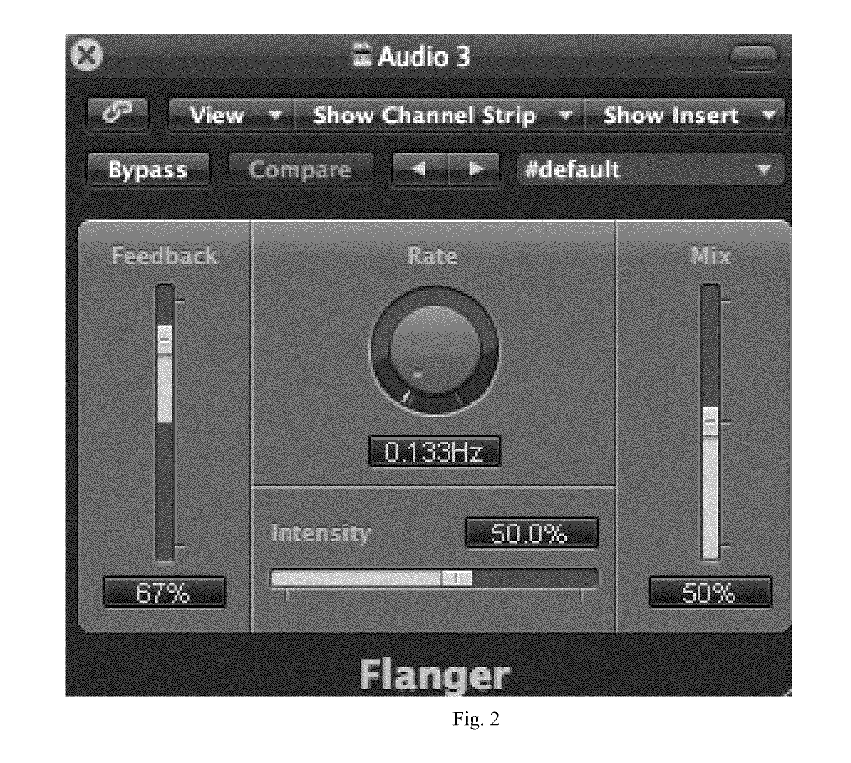

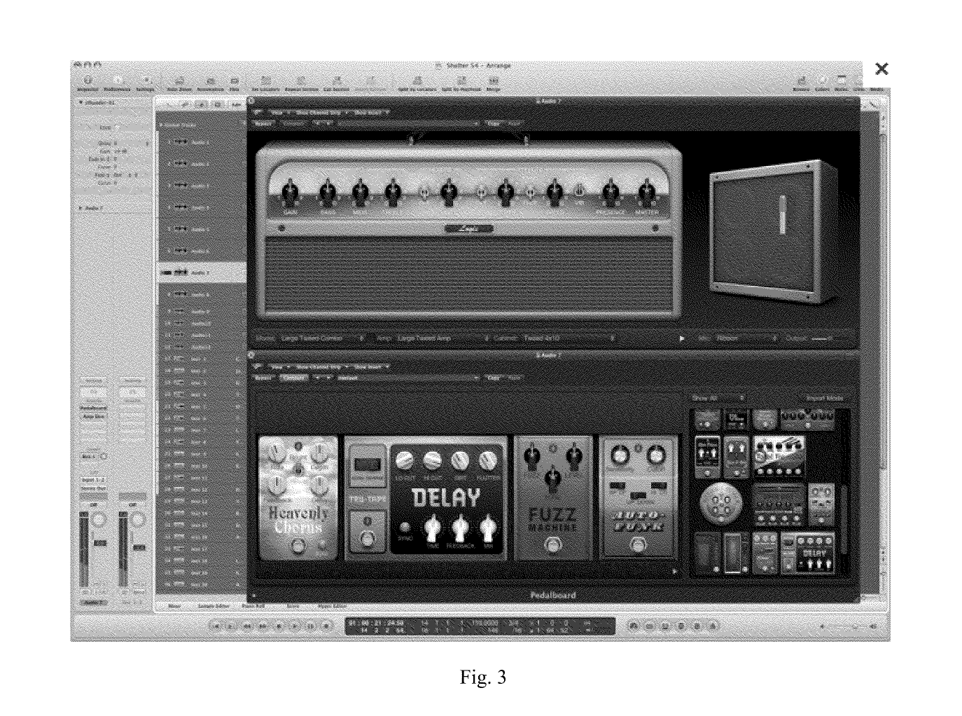

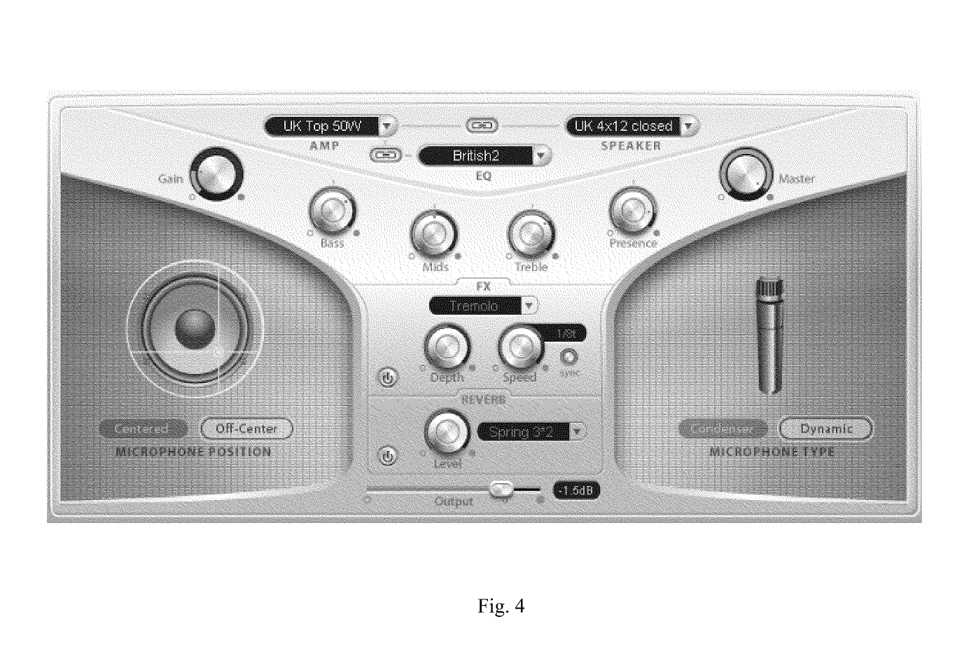

### DETAILED DESCRIPTION OF THE EMBODIMENTS

The present application allows musicians to have complete autonomy over the way they sound, and further provides an online network in which musicians can share/sell their sound effects.

As noted above, the present application provides an online network (similar to ITUNES) in which musicians can share and/or sell the sound effects that they have created to the network of musicians. For example, an online center is provided in which musicians can “shop” for sounds that they like, by listening to a sample, and being able to download the effect onto their pedal boards. This creates a “social network” in which musicians are able to not only share, but also play each other's sound effects. This network creates a new universe in which musicians are not bound to the sounds that sound effects companies sell on the market. Instead, a musician can choose to put the effects that (s)he creates up for free, or for a price (s)he deems to be appropriate. This gives musicians the opportunity to take the sounds that they hear in their head, and to turn the sounds into something tangible. In an embodiment, the content is provided by the people who use the program.

As noted above, the present application provides a software program that is purchased through major music distribution retailers, such as GUITARCENTER and SAMASH. When the user opens the program, a screen appears that allows the user to design a “digital” picture of how the user wants the pedal to look like. As illustrated in the drawing figures, the user may select from a variety of different pedal shapes and enhance them, such as by changing colors. Alternatively, the user may upload a photograph that will be on the pedal. This same color/image appears when the effect is posted online, provided the user decides to utilize this feature.

When preparing to create a sound effect, the user may be presented with a variety of “standard” effects to choose as a starting place, or the user may choose a completely blank project to start from scratch. Example of pre-created basic effects include “blues driver,” “flanger,” “chorus,” “delay,” or other known and preferably non-copyright protected effects. Moreover, the user may “stack” a plurality of effects over each other, for example, to create very unique and original sound effects. The user may have complete autonomy over the sound, as well as have access to virtually every aspect of a particular sound effect. For example, the user may manipulate various features, such as volume, reverb, and more complex effects such as stage, delay timing, or the like. The possibilities are almost endless, especially when considering all the different sounds that can be created for recording programs. In order to have a ‘hands on’ feel, the user will have their instrument plugged into the pedal (which is plugged into the computer via a USB drive), and will be able to sample their effects in real time.

In accordance with the present application, an online network is provided that is relatively simple to use. For example, after a user is satisfied with a custom-built effects pedal, the user uploads the effects onto an online database via the user's respective username. This username may be created when the user first installs the program on his/her computer. The user has the opportunity to give the new pedal a name (each name should be unique so simple names such as ‘distortion’ will be rejected), and may be able to post them online for free, or for a price of their choice. In an embodiment, profit may be made, for example, by receiving a percentage of all effects and/or sold through the network. Similar to that of ITUNES and YOUTUBE, musicians may create their own businesses by making pedals and effects that other consumers may choose to purchase and play their pedals. A hierarchy of users can be created based on particular users popularity on the site. There will be sections on the site, which may include ‘top free,’ and ‘top effects.’ All users will have access to an online store with potentially millions of unique effects, which they can download. Users have the ability to decide whether or not to allow other users who download an effect and/or pedal to be able to manipulate it further if they choose to, or whether the effect and/or pedal is ‘locked’ and unable to be accessed.

Users may, in accordance with the present application, start their own pedals/effects companies and may further choose to keep their effect formulas a secret. Users will be notified of whether they can alter the effect or not before they choose to download/purchase the effect. Potential buyers may preview a 10-40 second recording of an effect, which is provided when the user posts the effect. As well, each user may be given their own ‘page’, which can be sent to their peers for easy sharing and networking. A rating system is further supported, in which users can choose to ‘rate’ the effects that other users have produced. One of the main ideas behind the site, as well as allowing users to define their own effect prices, is autonomy. If users want to try and profit and start a business from this site, they have complete control over what business decisions they will make in that regard.

Another unique feature in accordance with the present application is a digital guitar function. The technology for a type of MIDI based effect is not currently available. Every note on a guitar has a unique frequency. These frequencies are picked up and manipulated with an effect before coming out of the amplifier. The digital guitar functionality in accordance with the present application takes this idea to a higher level. A musician has the ability to include small digital sound clips, which may by anything from a voice speaking, to an explosion, to a turntable scratch, and when the musician hits that note, the amplifier will produce that clip. The user may choose to put digital effects on specific notes, or on a specific region of the guitar so that (s)he can play a typical (preferably electric) guitar while now including digital effects. This feature may be advertised as the “main wonder” of this program, and fuses the ideas of what DJs can do on their laptops with what musicians can do with their instruments. This creates a completely unexplored area of playing in which musicians can now begin including more than notes in their sound, and in their guitar solos.

Accordingly, the following lists some of the features disclosed herein: 1) software for creating/building effects; 2)a pedal board that these effects can be uploaded onto (may potentially be outsourced); 3) an online network in which these effects can be traded and/or sold; and 4) the digital guitar.

Although the present invention has been described in relation to particular embodiments thereof, many other variations and modifications and other uses will become apparent to those skilled in the art.

What is claimed is:

1. A method of playing a digital sound clip the method comprising:
creating a digital sound clip;
hitting a note on a guitar; and
producing, by an amplifier, the digital sound clip in response to hitting of the note.

2. The method of claim 1, wherein the digital sound clip is downloaded after the creating of the digital sound clip.

3. The method of claim 2, further comprising manipulating the digital sound clip after the digital sound clip is downloaded, before the note is played on the guitar.

4. A system and method substantially as shown and described herein.
